(19) United States
(12) Patent Application Publication
(10) Pub. No.: US 2020/0258026 A1
(43) Pub. Date: Aug. 13, 2020

(54) SERVICE PERSON SELECTING DEVICE, MACHINE LEARNING DEVICE, AND MACHINE LEARNING METHOD

(71) Applicant: SEIKO EPSON CORPORATION, Tokyo (JP)

(72) Inventors: Hajime NISHIZAWA, Shiojiri-shi (JP); Hiroyuki GUNJI, Shiojiri-shi (JP)

(21) Appl. No.: 16/783,861

(22) Filed: Feb. 6, 2020

(30) Foreign Application Priority Data
Feb. 8, 2019 (JP) 2019-021301

(51) Int. Cl. G06Q 10/06; G06Q 10/10; G06Q 10/00; G06N 5/04; G06N 20/00

(52) U.S. Cl. CPC G06Q 10/063112; G06Q 10/105; G06N 20/00; G06N 5/04; G06Q 10/20

(57) ABSTRACT

A service person selecting device includes a storage that stores a machine-learned model subjected to machine learning using teaching data in which service person selection information, which is at least one of error information of a printing device, estimated required time period information of service persons that is related to estimated required time periods up to times when the service persons perform a task of maintaining the printing device in which an error has occurred, skill information of the service persons, and held component information of the service persons, is associated with a service person dispatched to maintain the printing device in which the error has occurred, and a controller that acquires the service person selection information and uses the acquired service person selection information and the machine-learned model to select a service person to be dispatched to maintain the printing device in which the error has occurred upon the occurrence of the error in the printing device.

The present application is based on, and claims priority from JP Application Serial Number 2019-021301, filed Feb. 8, 2019, the disclosure of which is hereby incorporated by reference herein in its entirety.

### BACKGROUND

### 1. Technical Field

The present disclosure relates to a service person selecting device, a machine learning device, and a machine learning method.

### 2. Related Art

A system for dispatching a service person to an electronic device in which a failure has occurred is traditionally known. For example, JP-A-2015-225404 describes that a destination (service person who is dispatched to perform support or an operator who performs phone support) to which a support request is to be notified is determined based on a support history and support state of handling for the failure that has occurred in the electronic device.

However, it has been difficult to select a service person who is dispatched to perform a maintenance task from among multiple service persons.

### SUMMARY

An object of the disclosure is to easily select a service person to be dispatched.

To achieve the foregoing object, according to a first aspect of the disclosure, a service person selecting device includes a storage unit that stores a machine-learned model subjected to machine learning using teaching data in which service person selection information, which is at least one of error information of a printing device, estimated required time period information of service persons that is related to estimated required time periods up to times when the service persons perform a task of maintaining the printing device in which an error has occurred, skill information of the service persons, and held component information of the service persons, is associated with a service person dispatched to maintain the printing device in which the error has occurred, and a controller that acquires the service person selection information and uses the acquired service person selection information and the machine-learned model to select a service person to be dispatched to maintain the printing device in which the error has occurred upon the occurrence of the error in the printing device.

In the foregoing configuration, the machine-learned model is generated by the machine learning using the teaching data in which the service person selection information is associated with the service person actually dispatched in an environment indicated in the service person selection information. According to the foregoing configuration, when an error occurs in the printing device, the service person selection information acquired when the error occurs, and the machine-learned model are used to enable a service person who is to be dispatched to be easily selected from among the multiple service persons.

The service person selection information included in the teaching data to be used in the machine learning, and the service person selection information acquired to select a service person when an error occurs have a common data configuration, but data included in the service person selection information included in the teaching data may be different from data included in the service person selection information acquired when the error occurs.

According to the first aspect, the estimated required time period information may include information of transportation available to the service persons and transportation information on transportation from current positions of the service persons to a location at which the printing device exists.

According to the foregoing configuration, it is possible to improve the accuracy of the estimated time periods required for the service persons to move from the current positions of the service persons to the location at which the printing device exists.

According to the first aspect, when the service persons perform maintenance tasks, the estimated required time period information may include estimated remaining time periods up to the completion of the maintenance tasks by the service persons.

According to the foregoing configuration, it is possible to improve the accuracy of estimated time periods required for the service persons to move from current positions (locations at which printing devices being subjected to the maintenance tasks exist) of the service persons to locations at which other printing devices (that are to be newly subjected to maintenance tasks and are not the printing devices being subjected to the maintenance tasks) exist.

According to the first aspect, the machine-learned model may be subjected to the machine learning again based on a result indicating whether the selected service person has accepted a dispatch request.

According to the foregoing configuration, when the service person selection information has a certain characteristic, it is possible to learn that a certain service person does not accept the dispatch request but another service person accepts the dispatch request. As a result, when the service person selection information has the certain characteristic, it is possible to reduce the probability that a service person who may not accept the dispatch request is selected and it is possible to shorten a time period up to the time when a service person to be actually dispatched is determined.

According to the first aspect, the skill information of the service person dispatched may be updated based on a result of maintenance support by the service person dispatched.

According to the foregoing configuration, since the skill information is updated based on the result of the maintenance support, a service person can be selected based on the updated skill information in the next or later service person selection.

To achieve the foregoing object, according to a second aspect of the disclosure, a machine learning device includes a controller that acquires teaching data in which service person selection information, which is at least one of error information of a printing device, estimated required time period information of service persons that is related to estimated required time periods up to times when the service persons perform a task of maintaining the printing device in which an error has occurred, skill information of the service persons, and held component information of the service persons, is associated with a service person dispatched to maintain the printing device in which the error has occurred, and that executes, based on the teaching data, machine learning on a model for receiving the service person selection information and outputting information of a service person to be dispatched to maintain the printing device in which the error has occurred.

According to the foregoing configuration, the machine learning model for selecting, based on the service person selection information, a service person to be dispatched to maintain the printing device can be obtained.

To achieve the foregoing object, according to a third aspect of the disclosure, a machine learning method includes acquiring teaching data in which service person selection information, which is at least one of error information of a printing device, estimated required time period information of service persons that is related to estimated required time periods up to times when the service persons perform a task of maintaining the printing device in which an error has occurred, skill information of the service persons, and held component information of the service persons, is associated with a service person dispatched to maintain the printing device in which the error has occurred; and executing, based on the teaching data, machine learning on a model for receiving the service person selection information and outputting information of a service person to be dispatched to maintain the printing device in which the error has occurred.

According to this method, the machine learning model for selecting, based on the service person selection information, a service person to be dispatched to maintain the printing device can be obtained.

To achieve the foregoing object, according to a fourth aspect of the disclosure, a service person selection program causes a computer to function as a storage unit that stores a machine-learned model subjected to machine learning using teaching data in which service person selection information, which is at least one of error information of a printing device, estimated required time period information of service persons that is related to estimated required time periods up to times when the service persons perform a task of maintaining the printing device in which an error has occurred, skill information of the service persons, and held component information of the service persons, is associated with a service person dispatched to maintain the printing device in which the error has occurred, and a controller that acquires the service person selection information and uses the acquired service person selection information and the machine-learned model to select a service person to be dispatched to maintain the printing device in which the error has occurred upon the occurrence of the error in the printing device.

The computer executes the program, thereby selecting, based on the service person selection information, a service person to be dispatched to maintain the printing device.

To achieve the foregoing object, according to a fifth aspect of the disclosure, a service person selecting device includes a storage unit that stores a machine-learned model subjected to machine learning using teaching data in which service person selection information, which is at least one of error information of an electronic device, estimated required time period information of service persons that is related to estimated required time periods up to times when the service persons perform a task of maintaining the electronic device in which an error has occurred, skill information of the service persons, and held component information of the service persons, is associated with a service person dispatched to maintain the electronic device in which the error has occurred; and a controller that acquires the service person selection information and uses the acquired service person selection information and the machine-learned model to select a service person to be dispatched to maintain the electronic device in which the error has occurred upon the occurrence of the error in the electronic device.

According to the foregoing configuration, when an error occurs in the electronic device, the service person selection information acquired when the error occurs and the machine-learned model are used to enable a service person to be dispatched to be easily selected from among the multiple service persons.

### BRIEF DESCRIPTION OF THE DRAWINGS

FIG. 1 is a block diagram depicting a service person selecting device (machine learning device).

FIG. 2 is a diagram depicting an example of a printing device database (DB).

FIGS. 3A, 3B, and 3C are diagrams depicting an example of a service person selection DB.

FIG. 4 is a schematic diagram depicting an example of input and output of a machine learning model.

FIG. 5 is a flowchart of a machine learning process.

FIG. 6 is a sequence diagram depicting a maintenance sequence.

FIG. 7 is a sequence diagram depicting a maintenance sequence.

### DESCRIPTION OF EXEMPLARY EMBODIMENTS

Hereinafter, embodiments of the disclosure are described in the following order.

### (1) Configuration of Service Person Selecting Device (Machine Learning Device)

### (2) Collection of Service Person Selection Information

### (3) Machine Learning Process

### (4) Maintenance Sequence

### (5) Other Embodiment

### (1) Configuration of Service Person Selecting Device (Machine Learning Device)

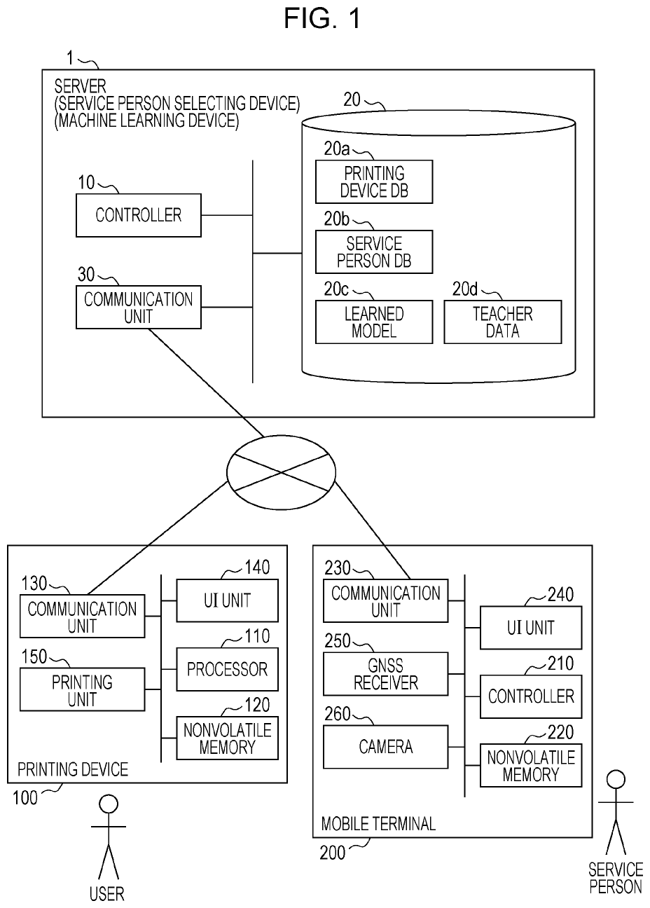

FIG. 1 is a block diagram depicting a configuration of a server 1 serving as a service person selecting device and a machine learning device according to an embodiment of the disclosure. The server 1 is a computer that is able to communicate with multiple printing devices via a network such as the Internet. FIG. 1 depicts a printing device 100. The server 1 is able to communicate with multiple mobile terminals via the network. The mobile terminals are carried by service persons who perform a task of maintaining the printing devices. The number of service persons is two or more. Each of the service persons carries a respective one of the mobile terminals. FIG. 1 depicts a mobile terminal 200. In the embodiment, the server 1 has a function of selecting, from among the multiple service persons, a service person to be dispatched to a location at which a printing device that is any of the printing devices and in which an error has occurred is installed in order to perform a task of maintaining the printing device, when the server 1 detects that the error has occurred in the printing device.

To enable the foregoing function, the server 1 includes a controller 10, a storage unit 20, and a communication unit 30. The controller 10 includes a central processing unit (CPU), a read-only memory (ROM), and a random-access memory (RAM) and executes various programs including a service person selection program (not depicted) stored in the storage unit 20 and a machine learning program (not depicted) stored in the storage unit 20. The controller 10 enables a function related to machine learning by executing the machine learning program. The controller 10 executes the service person selection program, thereby enabling a function of selecting a service person to be dispatched. The controller 10 may include an application specific integrated circuit (ASIC) and a graphics processing unit (GPU).

The communication unit 30 includes a communication interface circuit configured to communicate with another device via the network such as the Internet. The controller 10 executes the machine learning program and the service person selection program, thereby communicating with multiple printing devices including the printing device 100 and multiple mobile terminals including the mobile terminal 200 via the communication unit 30.

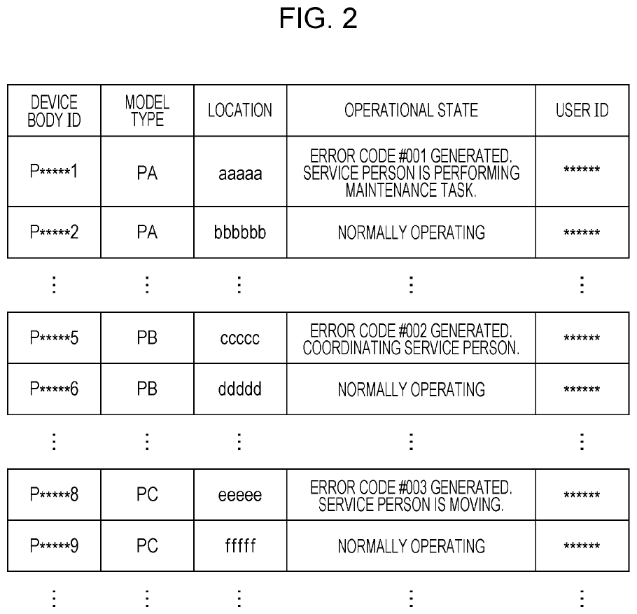

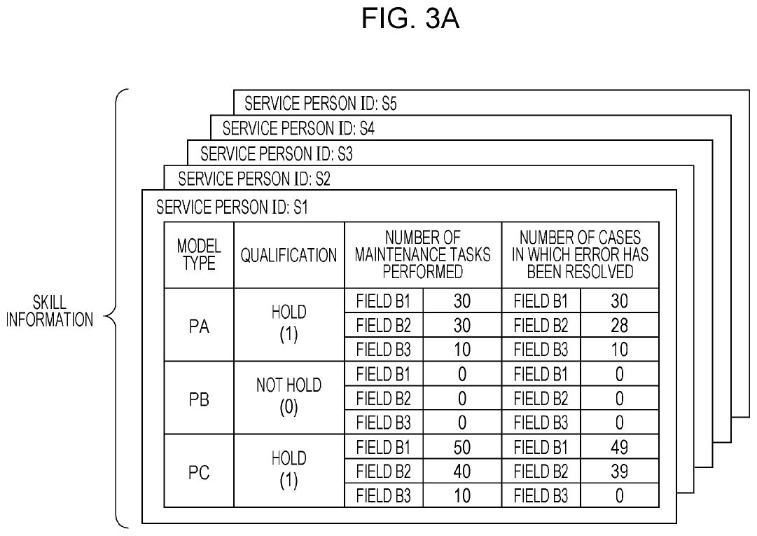

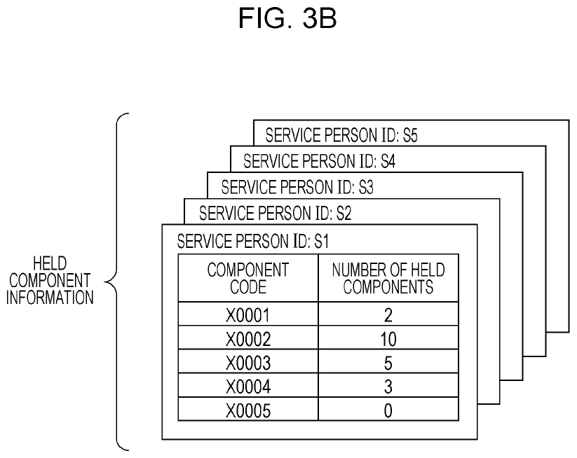

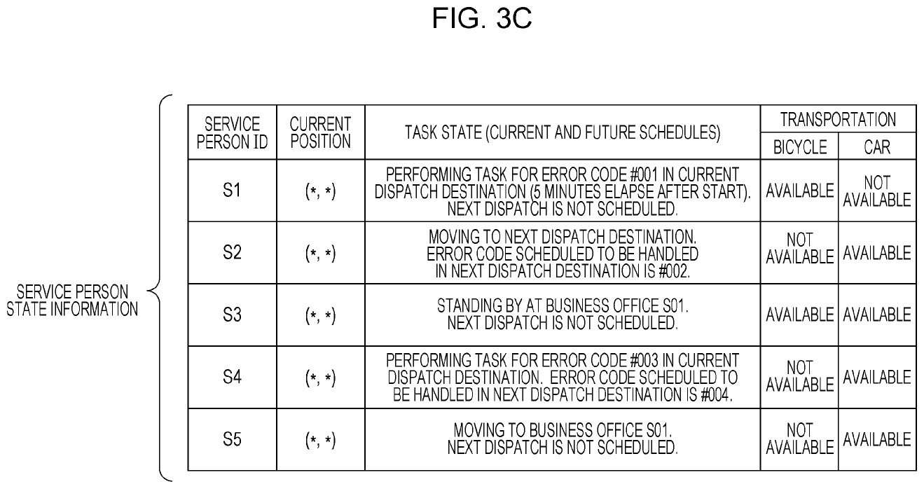

In the storage unit 20, a printing device DB 20a and a service person DB 20b are stored. The printing device DB 20a is a database to be used to manage information for each of device bodies of the printing devices. As depicted in FIG. 2, device IDs, model types, locations, operational states, user IDs, and the like are stored in the printing device DB 20a. The service person DB 20b is a database to be used to manage information for each of the service persons. In the embodiment, as depicted in FIGS. 3A, 3B, and 3C, the service person DB 20b includes skill information, held component information, and status information. The printing device DB 20a and the service person DB 20b are described later in detail. Teaching data 20d to be used in machine learning described later and a machine-learned model 20c generated by the machine learning are stored in the storage unit 20.

### Configuration of Printing Device

A configuration of the printing device 100 is described below. The printing device 100 includes a processor 110, a nonvolatile memory 120, a communication unit 130, a user interface (UI) unit 140, and a printing unit 150. The processor 110 includes a CPU, a ROM, and a RAM, which are not depicted. The processor 110 executes various programs stored in the nonvolatile memory 120 to control the units of the printing device 100. The processor 110 may be composed of a single chip or may be composed of multiple chips. For example, the processor 110 may include an ASIC, instead of the CPU. Alternatively, the processor 110 has a configuration in which the CPU and the ASIC collaborate with each other.

The communication unit 130 includes a communication interface circuit that communicates, in accordance with various communication protocols, with various removable memories attached to the printing device 100 and another device connected to the printing device 100 via a cable or wirelessly. The processor 110 is able to communicate with the server 1 via the communication unit 130.

The UI unit 140 includes a touch panel display, various keys, and a switch. The processor 110 acquires a detail of an operation performed by a user (of the printing device 100) via the UI unit 140. The processor 110 displays various information on the display of the UI unit 140 and notifies the information to the user. The printing unit 150 includes an actuator, a sensor, a driving circuit, a mechanical component, and the like, which are used to execute printing on various print media via one or more of known printing methods such as an ink jet printing method and an electrophotographic printing method.

### Configuration of Mobile Terminal

Next, a configuration of the mobile terminal 200 is described. The mobile terminal 200 is carried by a service person and may be a tablet terminal, a smartphone, or the like. The mobile terminal 200 includes a controller 210, a nonvolatile memory 220, a communication unit 230, a UI unit 240, a global navigation satellite system (GNSS) receiver 250, and a camera 260. The controller 210 includes a CPU, a RAM, and a ROM, which are not depicted. The controller 210 executes various programs stored in the nonvolatile memory 220 to control the units of the mobile terminal 200. The communication unit 230 includes a communication interface circuit that communicates, in accordance with various communication protocols, with various removable memories attached to the mobile terminal 200 and another device connected to the mobile terminal 200 via a cable or wirelessly. The processor 210 is able to communicate with the server 1 via the communication unit 230.

The UI unit 240 includes a touch panel display, various keys, a switch, a microphone, and a speaker. The controller 210 acquires a detail of an operation performed by the service person via the UI unit 240. The controller 210 displays various information on the display of the UI unit 240 and notifies the information to the service person. The controller 210 acquires input audio data indicating audio collected by the microphone. The controller 210 outputs various audio from the speaker.

The GNSS receiver 250 receives a radio wave from a global navigation satellite system (GNSS) and outputs a signal to be used to calculate the current position of the mobile terminal 200 via an interface (not depicted). The controller 210 periodically acquires the current position of the mobile terminal 200 based on the signal output from the GNSS receiver 250. The current position of the mobile terminal 200 may be corrected based on information transmitted from a wireless local access network (LAN) access point (not depicted). The controller 210 notifies the current position of the mobile terminal 200 to the server 1 via the communication unit 230. The camera 260 captures an image of a region in the vicinity of the mobile terminal 200. The controller 210 causes the camera 260 to capture the image based on an operation by the service person. The controller 210 causes the camera 260 to read a barcode, a two-dimensional code, or the like and executes processing corresponding to information indicated by the barcode, the two-dimensional code, or the like.

### (2) Collection of Service Person Selection Information

Next, updates of the printing device DB 20a and service person DB 20b stored in the storage unit 20 of the server 1 are described. In the printing device DB 20a, device IDs, which are specific to the device bodies of the printing devices and assigned to the device bodies of the printing devices, are managed. The controller 10 of the server 1 acquires model types of the device bodies, locations at which the device bodies exist, operational states, user IDs of users who use the device bodies, and the like based on the device IDs. For example, in the case where the user of the printing device registers a maintenance service, a device ID of a device of the printing device, a model type of the device, a location at which the printing device exists, a user ID, and the like are registered in the printing device DB 20a. The location at which the printing device exists may be expressed by an address or coordinates. After a procedure including the user registration is completed, the printing device 100 may communicate with the server 1. For example, when an error occurs in the printing device 100, the printing device 100 transmits information to the server 1. For example, the server 1 notifies information on dispatch of a service person or the like to the printing device 100.

When an error occurs in the printing device 100, the processor 110 detects the error via the sensor for sensing states of the units of the printing devices 100. The processor 110 identifies an error code indicating a detail of the error based on a result of the sensing. The error code correlates with a field of a skill necessary for maintenance support for the error indicated by the error code, a standard task time period for a maintenance task, a component necessary for the maintenance task, and the like. The processor 110 notifies the identified error code and the device ID of the printing device 100 to the server 1 via the communication unit 130. The device IDs are information identifying the device bodies and assigned to the device bodies of the printing devices. The device ID and model type of the printing device 100 are stored in the ROM or the nonvolatile memory 120 in advance.

Upon receiving the error code and the device ID from the printing device 100, the controller 10 of the server 1 updates an operational state associated with the device ID in the printing device DB 20a (refer to FIG. 2). An operational state of a device of a printing device in which an error occurs may indicate an error code of the error that occurs, a state (indicating that a service person is being coordinated, a service person is moving to a location at which the device exists, or a service person is performing a maintenance task) of handling for the error, or the like, for example.

The service person DB 20b includes skill information, held component information, and service person state information, as depicted in FIGS. 3A, 3B, and 3C. Service person IDs are information identifying the service persons. The skill information, the held component information, and the service person state information are recorded for each of the service person IDs.

A qualification that permits a service person to perform a task of maintaining a printing device is defined for each of the model types of printing devices. For example, it is defined that, in the case where a service person S1 holds a qualification for a model type PA but does not hold a qualification for a model type PB, the service person S1 is permitted to perform a task of maintaining a printing device of the model type PA but is not permitted to perform a task of maintaining a printing device of the model type PB. In the embodiment, for each of the service persons, the model types of printing devices, information indicating whether the service person holds qualifications for the model types, the numbers of maintenance tasks performed of printing devices of the model types, and the numbers of cases in which errors of printing devices of the model types have been resolved are recorded as the skill information.

Each of the numbers of maintenance tasks performed is the number of times that a corresponding service person has actually been dispatched and has performed a maintenance task. Each of the numbers of cases in which errors have been resolved is the number of times that a corresponding service person has actually been dispatched and has performed a maintenance task and resolved a failure (or removed an error) via the maintenance task (the number of maintenance tasks performed≥the number of cases in which an error has been resolved). The following case is described as an example. In the case, a certain service person visits a location at which a certain printing device exists to maintain the certain printing device, does not resolve an error by performing a task on the visit, revisits the location on a later day, performs a maintenance task, and resolves the error. In this case, in the embodiment, the number of maintenance tasks performed is 2 (2 times) and the number of cases in which an error has been resolved is 1 (on the revisit). In the embodiment, the ratio of the number of cases in which an error has been resolved to the number of maintenance tasks performed is calculated as a resolution rate, and the resolution rate is one of values to be input to a machine learning model described later. In the foregoing case, the resolution rate is 0.5 (50%).

In the embodiment, the number of maintenance tasks performed and the number of cases in which an error has been resolved are calculated for each of the model types and for each of fields (B1 to B3) of printing devices of each of the model types. The fields may be a field of mechanisms for transporting print media, a field of print heads and carriages, a field of networks and communication, and the like, for example. In the embodiment, to simplify the description, the number of service persons, the number of model types of printing devices, the number of fields, the number of types of components, and the like are in a range of 3 to 5 and are an example and may be values larger than 5.

For each of the service person IDs and each of component codes, the number of held components indicated by the component code is recorded as the held component information. Each of the service persons operates a mobile terminal carried by the service person and enters, in the mobile terminal, component codes of components owned (held) by the service person and the number of components owned (held) by the service person. It is sufficient if the components indicated in the held component information are used to maintain a printing device. For example, the components may be replacement components for printing devices, tools necessary to fix the printing devices, and items (for example, ink and print media) necessary to confirm operations of the printing devices.

When the number of held components is changed due to the supply of a component, the consumption of a component for a maintenance task, or the like, a service person enters the number of added or removed held components from a mobile terminal carried by the service person to update the held component information of the service person DB 20b. This entry task may be automatically performed by causing the camera 260 of the mobile terminal to read barcodes printed on the components or the like. Alternatively, the number of held components may be reflected in the held component information even when the service person does not explicitly enter the number of added or removed held components. For example, when component codes and the number of components to be used (consumed) to remove an error are determined in advance and the service person notifies the server 1 via the mobile terminal 200 that the error has been removed, the number of components indicated by the foregoing component codes may be reduced by the foregoing number in held component information of the service person. The held component information may be updated once a day.

As the service person state information, a current position, a task state, and transportation are recorded for each of the service person IDs. In response to the reception of information indicating the current position of the mobile terminal 200 from the mobile terminal 200 carried by the service person, the controller 10 updates the current position indicated in the service person state information. In addition, the controller 10 updates a current state of the service person and a future schedule of the service person as a task state. For example, when the service person stands by (or waits for a dispatch request) and accepts the dispatch request notified by the server 1, the controller 10 updates the task state of the service person to “moving to a next dispatch destination”. In addition, the controller 10 records an error code scheduled to be handled in the next dispatch destination.

For example, when the controller 10 detects that the service person has arrived at the dispatch destination and started to perform a maintenance task, the controller 10 updates the task state of the service person to “performing a task”. In addition, the controller 10 records an error code of an error on which the service person is performing the maintenance task. The controller 10 may determine whether the service person has started to perform the maintenance task by detecting that the current position of the service person matches a location at which a printing device exists in the next dispatch destination. When the maintenance task is started, the next dispatch destination is treated as the current dispatch destination.

A standard task time period for a maintenance task is defined for each of error codes in advance. The controller 10 multiplies a standard task time period defined for an error code by a coefficient corresponding to a skill level of a service person, thereby estimating a task time period required for the service person to perform a maintenance task on an error indicated by the error code. For example, a coefficient of a service person whose skill level is equal to or higher than a standard level is 1, and a coefficient of a service person whose skill level is lower than the standard level is a value (of, for example, 1.3) larger than 1. By setting coefficients in this manner, the accuracy of task time periods estimated based on skill levels and required for the service persons to perform maintenance tasks can be improved. A standard task time period defined for each of the error codes may be obtained by collecting past time periods for performed tasks based on a model type and the error code and setting the standard task time period based on a statistical value of the collected time periods.

For example, when the foregoing resolution rate is smaller than a predetermined value, a skill level may be treated as a level lower than the standard level. For example, when the foregoing number of maintenance tasks performed is smaller than a predetermined value, the skill level may be treated as a level lower than the standard level. Each of the coefficients may be set based on a combination of the number of maintenance tasks performed and the resolution rate. A task time period estimated in the foregoing manner is notified to a service person requested to be dispatched and serves as one of items to be used to determine whether the service person accepts a dispatch request. In the calculation of an estimated time period required for a service person performing a maintenance task to move to a next dispatch destination, the task time period estimated in the foregoing manner is used to calculate an estimated remaining time period for the maintenance task performed in a current dispatch destination. For example, the controller 10 calculates an elapsed time period from the time when the controller 10 detects the start of the maintenance task by the service person after the arrival of the service person at the current dispatch destination to the current time, and subtracts the elapsed time period from the estimated task time period, thereby calculating the estimated remaining time period for the maintenance task performed in the current dispatch destination. The controller 10 adds the estimated remaining time period to a movement time period (described later), thereby calculating the estimated required time period of the corresponding service person.

In the service person state information (refer to FIG. 3C), the transportation is information indicating transportation available to the service persons. The available transportation is used to calculate movement time periods required for the service persons to move to next dispatch destinations (locations at which printing devices exist). The movement time periods are included in estimated required time periods up to times when the service persons perform tasks of maintaining the printing devices in which errors have occurred. In the embodiment, a bicycle and a car (with four wheels) are exemplified as the transportation. For example, a motorcycle, walk, and public transportation (train and the like) may be included in the transportation. Time periods for movements from current positions of the service persons to dispatch destinations (locations at which the printing devices exist) may be different from each other depending on the transportation to be used by the service persons. Traffic information (information of traffic congestion on roads, delay information of public transportation, and the like) that may affect the calculation of the movement time periods may be different from each other depending on the transportation.

Transportation available to a service person who is being dispatched may be transportation that is being used by the service person, for example. Information of the transportation that is being used by the service person may be entered by the service person in advance or may be determined based on a trajectory of the current position of the service person and a movement speed of the service person. For example, transportation that exists at a business office may be selected for a service person who stands by at the business office (when a bicycle exists at the business office, the bicycle may be selected, or when a car exists at the business office, the car may be selected, or when the bicycle and the car exist at the business office, the bicycle and the car may be selected). For example, the transportation may be limited based on types of driver licenses held by the service persons.

In the embodiment, the controller 10 requests a route search server (not depicted) to search for routes and acquires the foregoing movement time periods. The controller 10 transmits, to the route search server, information indicating the current positions of the service persons, a location at which a printing device in which an error has occurred exists, and transportation available to the servicer persons. Then, the controller 10 requests the route search server to search for routes. When the transportation is cars, the route search server searches for routes from the current positions of the servicer persons to the location at which the printing device exists, based on traffic congestion information (transportation information) received from a transportation information center (not depicted), and the route search server acquires movement time periods. When the transportation is public transportation, the route search server searches for routes from the current positions of the servicer persons to the location at which the printing device exists, based on delay information (transportation information) acquired from a public transportation institution, and the route search server acquires movement time periods. When transportation available to a service person is transportation of multiple types, the route search server may acquire time periods for movements of the transportation of the multiple types and use the shortest time period.

The foregoing route search may be enabled using a neural network, and the movement time periods may be acquired by the foregoing route search. The information indicating the transportation available to the service persons and transportation information on transportation to be used by the service persons to move from the current positions of the service persons to the location at which the printing device exists may be data to be input to a neural network model. The transportation information to be input may be traffic congestion degrees (heavily congested traffic condition, congested traffic condition, and non-congested condition) in regions in the vicinity of the current positions of the service persons, traffic congestion degrees (heavily congested traffic condition, congested traffic condition, and non-congested condition) in regions in the vicinity of the location at which the printing device exists, or the like.

For a service person who is on holiday (or is not at work), a time period obtained by adding a time period up to the time of the start of work on a next workday to a time period for a movement from a work place (for example, a business office) to a location at which a printing device exists may be calculated as an estimated required time period. Due to this operation, the estimated required time period is longer than an estimated required time period of another service person who is at work. Thus, the service person who is on holiday is hardly selected by the machine-learned model (described later), and it is possible to reduce the probability that a service person who is not to be dispatched is requested to be dispatched.

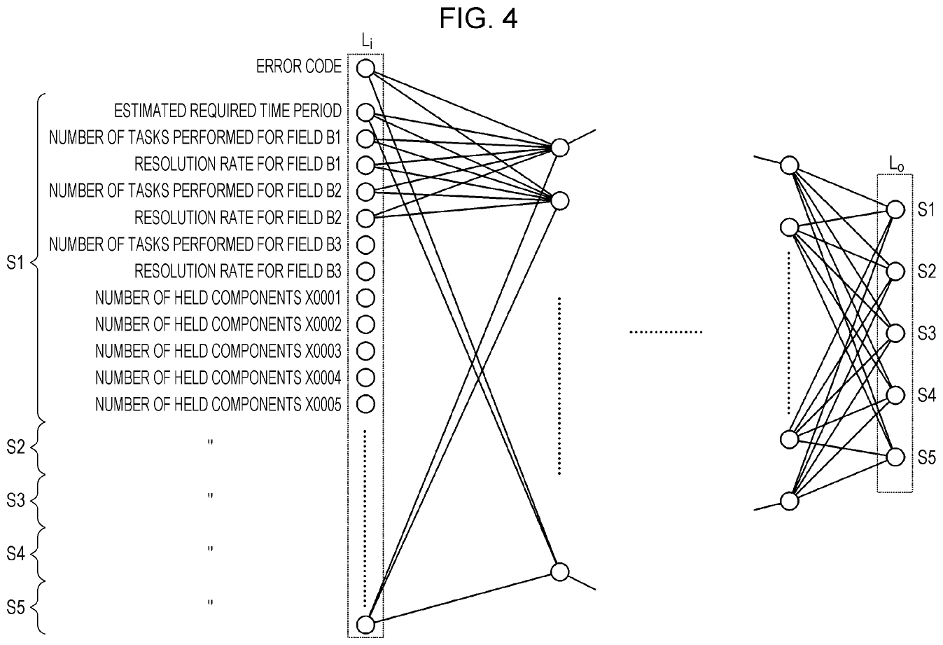

Upon receiving, from the printing device 100, a notification indicating that an error has occurred in the printing device 100, the controller 10 of the server 1 generates service person selection information based on the foregoing information. The generated service person selection information is data to be input to the machine learning model described later. FIG. 4 is a schematic diagram depicting input and output of the machine learning model according to the embodiment. In the embodiment, each of machine learning models is generated for a respective one of the model types of printing devices. For example, the machine learning models may be a model for printing devices of the model type PA, a model for printing devices of the model type PB, a model for printing devices of the model type PC, and the like. Service persons holding qualifications may vary depending on the model types. FIG. 4 depicts an example in which a qualification for printing devices of a certain model type is held by 5 service persons S1 to S5. In this case, an error code indicating a detail of an error that has occurred, and information (estimated required time periods, the numbers of maintenance tasks performed for each of the fields, resolution rates for each of the fields, and the numbers of held components for each of the component codes) on the service persons S1 to S5 are input to nodes of an input layer Lᵢ of the machine learning model. The data to be input to the input layer Lᵢ corresponds to the service person selection information. In this case, the service persons (S1 to S5) are associated with nodes of an output layer Lₒ of the machine learning model.

When the service persons S1 to S4 hold a qualification for printing devices of another model type, an error code and information on the service persons S1 to S4 are input to a model for printing devices of the other model type. The number of nodes of an output layer Lₒ of the model is 4 for the service persons S1 to S4.

### (3) Machine Learning Process

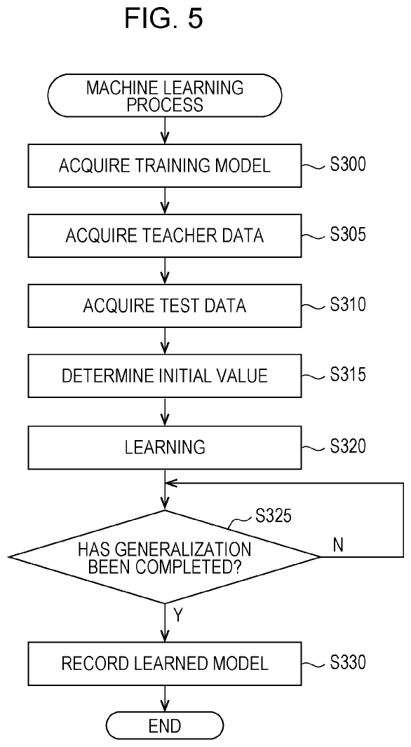

FIG. 5 is a flowchart depicting a machine learning process. The machine learning process may be executed at any time after the teaching data 20d with a predefined amount is accumulated. The teaching data 20d is data in which a service person actually dispatched to a printing device in which an error has occurred upon the occurrence of the error is associated with data (or the service person selection information) indicating states of all service persons (holding a qualification for the model type of the printing device in which the error has occurred) including other service persons and the printing device in which the error has occurred. The teaching data may include data accumulated before the neural network model for selecting a service person is implemented. As described above, after the implementation, other teaching data may be accumulated to execute relearning based on a result indicating whether a dispatch request has been accepted and a result of maintenance support.

When the machine learning process is started, the controller 10 acquires a training model (not depicted) (in step S300). In this case, the model is information indicating an equation for obtaining an association between data to be predicted and data of a result of the prediction. As depicted in FIG. 4, the embodiment describes, as an example, the model in which the data to be predicted is the service person selection information and in which the data of the result of the prediction indicates a service person.

The model may be variously defined as long as the input data is converted into output data. FIG. 4 is a diagram schematically depicting an example of the model to be used in the embodiment. In the embodiment, the neural network is used. In FIG. 4, the nodes of the neural network are indicated by white circles.

The service person selection information is input as input data to the input layer Lᵢ of the model according to the embodiment. The model according to the embodiment outputs information of a service person from the output layer Lₒ. The nodes of the output layer Lₒ are associated with the service persons (S1, S2, S3, S4, and S5). The model is standardized so that the sum of output values of the nodes of the output layer Lₒ is 1. It can be estimated that a service person associated with a node that is among the nodes of the output layer Lₒ and from which the largest value is output is to be dispatched when the data items of the service person selection information input to the input layer Lᵢ are acquired.

In step S300 of the flowchart depicted in FIG. 5, the training model is acquired. Training indicates a target to be learned. Specifically, the training model receives the data items of the service person selection information and outputs information of a service person, but associations between the service person selection information and the service persons may not be correct in an initial state. Specifically, although the number of layers formed by nodes and the number of nodes in the training model are determined, parameters (weights, biases, and the like) defining relationships between the input and output of the model are not optimized. The parameters are optimized during machine learning (or are trained).

The training model may be determined in advance. Alternatively, an operator who operates the server 1 may operate an UI unit (not depicted) included in the server 1 to input the training model so that the server 1 acquires the training model. In both cases, as indicated in an example depicted in FIG. 5, the controller 10 acquires, as the training model, the parameters of the neural network for outputting, based on the service person selection information, information of a service person to be dispatched.

Next, the controller 10 acquires teaching data (in step S305). In the embodiment, the teaching data 20d is recorded in the storage unit 20, and the controller 10 references the storage unit 20 and acquires the teaching data 20d. Then, the controller 10 acquires test data (in step S310). In the embodiment, the test data is obtained by extracting a portion of the teaching data 20d from the teaching data 20d. The test data is not used for the training.

Then, the controller 10 determines an initial value (in step S315). Specifically, the controller 10 gives the initial value to a variable parameter of the training model acquired in step S300. The initial value may be determined via one or more of various methods. For example, the initial value may be a random value, 0, or the like. Alternatively, an initial value for the weights and an initial value for the biases may be determined based on ideas different for the weights and the biases. The initial value may be adjusted so that the parameters are optimized during the learning.

Next, the controller 10 executes the learning (in step S320). Specifically, the controller 10 inputs the service person selection information included in the teaching data 20d acquired in step S305 to the training model acquired in step S300 and calculates output values of the output layer Lₒ. In addition, the controller 10 identifies an error based on a loss function indicating differences between output information of a service person and information, indicated in the teaching data 20d, of the service person. Then, the controller 10 repeatedly executes a process of updating the parameters a predefined number of times based on the derivative of the loss function with respect to the parameters. For example, in the case where there is teaching data in which the service person selection information when the service person (S1) was dispatched in the past is associated with the service person (S1), the parameters are updated so that output (S1, S2, S3, S4, and S5) obtained by inputting, to the model, the service person selection information when the service person (S1) was dispatched is close to (1, 0, 0, 0, 0).

The loss function may be any of various functions. For example, the loss function may be a cross-entropy error function or the like. A process of calculating the foregoing loss function is executed on all or some of the data items of the service person selection information included in the teaching data 20d, and the loss function for learning to be executed once is expressed by the average or sum of results of the process. After the loss function for the learning to be executed once is obtained, the controller 10 updates the parameters based on a predefined optimization algorithm, for example, the stochastic gradient descent or the like.

After the parameters are updated the predefined number of times in the foregoing manner, the controller 10 determines whether generalization of the training model has been completed (in step S325). Specifically, the controller 10 inputs the service person selection information indicated in the test data acquired in step S310 to the training model and acquires output indicating a setting. Then, the controller 10 acquires a matching degree between the output setting and a setting associated with the test data. In the embodiment, when the matching degree is equal to or larger than a threshold, the controller 10 determines that the generalization of the training model has been completed.

The validity of a hyperparameter may be verified as well as the evaluation of generalization performance. The hyperparameter is a variable amount other than the weights and the biases. Specifically, the controller 10 may verify the validity of the hyperparameter based on verification data in a configuration in which the number of nodes or the like is tuned. The verification data may be extracted from the teaching data via a process that is the same as or similar to step S310. The verification data is not used for the training, like the test data.

When the controller 10 determines that the generalization of the training model has not been completed in step S325, the controller 10 repeats step S320. Specifically, the controller 10 updates the weights and the biases. When the controller 10 determines that the generalization of the training model has been completed in step S325, the controller 10 records the machine-learned model (in step S330). Specifically, the controller 10 records the training model as the machine-learned model 20c in the storage unit 20. According to the foregoing configuration, the model (machine-learned model 20c) for selecting a service person to be dispatched to perform a task of maintaining a printing device can be generated.

### (4) Maintenance Sequence

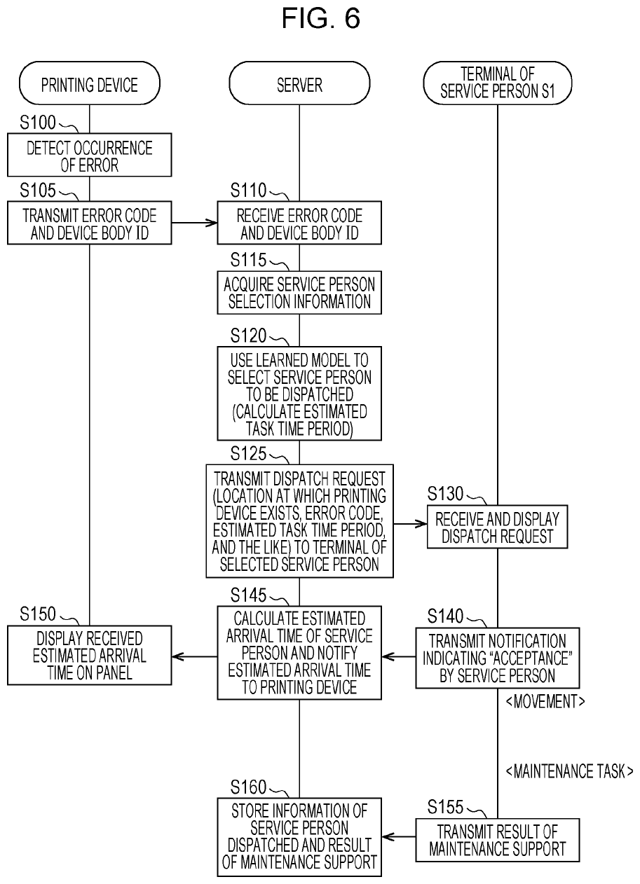

Next, an example of a sequence from the occurrence of an error through service person selection and a dispatch request to the storing of a result of maintenance support is described with reference to a sequence diagram of FIG. 6. In the printing device 100, when the processor 110 detects that an error has occurred (in step S100), the processor 110 transmits an error code and the device ID to the server 1 (in step S105). Specifically, the processor 110 identifies, based on output of the sensor, the error code indicating a detail of the error that has occurred. The processor 110 acquires the device ID stored in the nonvolatile memory 120. Then, the processor 110 transmits the error code and the device ID to the server 1 via the communication unit 130.

Upon receiving the error code and the device ID from the printing device 100 via the communication unit 30 (in step S110), the controller 10 of the server 1 acquires the service person selection information (in step S115). Specifically, the controller 10 references the printing device DB 20a (refer to FIG. 2) and identifies, from the device ID, the model type of the printing device and a location at which the printing device exists. Then, the controller 10 references the skill information, included in the service person DB 20b (refer to FIG. 3A), of the service persons and selects service persons holding a qualification for printing devices of the corresponding model type. The controller 10 calculates an estimated required time period for each of the selected service persons. Specifically, the controller 10 requests the route search server to search for routes (routes to be used by the transportation available to the service persons) from current positions of the service persons to the location at which the printing device exists. Then, the controller 10 acquires movement time periods.

When a task state (refer to FIG. 3C) of a service person indicates that the service person is performing a task in a current dispatch destination, the controller 10 acquires an elapsed time period from the time when the start of the maintenance task by the service person after the arrival of the service person at the current dispatch destination has been detected to the current time. The controller 10 calculates an estimated task time period required for the service person to perform the maintenance task for the error of the error code, based on a skill level of the service person and a standard task time period defined for the error code of the error for which the service person performs the task in the current dispatch destination. The controller 10 calculates an estimated remaining time period by subtracting the elapsed time period from the estimated task time period. For a service person whose task state indicates performing in the current dispatch destination, the controller 10 calculates, as the estimated required time period, a time period obtained by adding the estimated remaining time period to a movement time period.

The controller 10 references the skill information (refer to FIG. 3A) for each of the selected service persons and acquires the number of maintenance tasks performed for each of the fields and a resolution rate for each of the fields for each of the selected service persons. In addition, the controller 10 references the held component information (refer to FIG. 3B) for each of the selected service persons and acquires the number of held components for each of the component codes for each of the selected service persons. In the foregoing manner, the controller 10 acquires the service person selection information.

Subsequently, the controller 10 of the server 1 uses the machine-learned model 20c to select a service person to be dispatched (in step S120). Specifically, the controller 10 inputs the service person selection information acquired in step S115 to the nodes of the input layer Lᵢ of the machine-learned model 20c and calculates output values of the nodes of the output layer Lₒ. The controller 10 selects, as the service person to be dispatched, a service person associated with a node from which the largest value has been output. In addition, the controller 10 references skill information (refer to FIG. 3A) of the selected service person and acquires a skill level of the selected service person. The controller 10 calculates, based on the skill level and the standard task time period defined for the error code received in step S110, an estimated task time period required for the service person to perform a maintenance task for the error code.

Subsequently, the controller 10 of the server 1 transmits a dispatch request to a mobile terminal of the selected service person (in step S125). Specifically, the controller 10 transmits, to the mobile terminal of the service person, a notification indicating a location at which the printing device with the device ID received in step S110 exists, the error code (and a description of the error), the estimated task time period, and the dispatch request. This example describes that the service person S1 is selected. Thus, in step S125, the dispatch request is transmitted to the mobile terminal 200 carried by the service person S1.

Upon receiving the dispatch request from the server 1, the controller 210 of the mobile terminal 200 displays the received dispatch request on the display of the UI unit 240 (in step S130). Specifically, the location at which the printing device exists in the dispatch destination, the error code of the error that has occurred in the printing device (and the description of the error), the estimated task time period, and the like are displayed on the display of the mobile terminal 200. On the display, a selection section (for example, an “accept” button and a “refuse” button) for selecting whether the dispatch request is accepted or not is displayed.

When the service person confirms the details displayed on the display and accepts the dispatch request, the controller 210 transmits, to the server 1, a notification indicating that the service person has accepted the dispatch request (in step S140). Upon receiving the notification indicating the “acceptance” from the mobile terminal 200 of the service person requested to be dispatched, the controller 10 of the server 1 calculates an estimated arrival time of the service person and notifies the calculated arrival time to the printing device (in step S145). Specifically, the controller 10 calculates the estimated arrival time by adding the estimated required time period calculated for the service person in step S115 to the current time. The controller 10 transmits the calculated estimated arrival time to the printing device via the communication unit 30.

In step S120, the estimated arrival time may be calculated as well as the estimated task time period. In this case, in steps S125 and S130, the estimated arrival time may be transmitted to the mobile terminal. In addition, the estimated arrival time and transportation to be used by the service person to arrive at the estimated arrival time may be displayed on the display. Thus, a service person to which transportation of multiple types is available can easily recognize transportation to be used by the service person to move to the dispatch destination.

The processor 110 of the printing device 100 displays the estimated arrival time received from the server 1 on the display of the UI unit 140 (in step S150). Thus, the user of the printing device 100 can recognize the estimated arrival time of the service person.

After the service person selects “acceptance” for the dispatch request, the service person moves to the dispatch destination requested (using available transportation). After the service person arrives at the dispatch destination, the service person starts a maintenance task. When the maintenance task is completed, the service person enters a result of maintenance support to the mobile terminal 200. When the result of the maintenance support is entered, the controller 210 of the mobile terminal 200 transmits the result of the maintenance support and information identifying the dispatched service person (or the service person who carries the corresponding mobile terminal or the service person S1 in this example) to the server 1 (in step S155). The result of the maintenance support includes information indicating whether the error has been removed on this visit and information indicating an actual time period for the task. The result of the maintenance support may include information of the number of consumed components.

Upon receiving the information of the service person actually dispatched and the result of the maintenance support, the controller 10 of the server 1 causes the received information of the service person actually dispatched and the received result of the maintenance support to be stored in the storage unit 20 (in step S160). Specifically, the controller 10 updates an operational state of the corresponding printing device to “normally operating” in the printing device DB 20a based on the received result of the maintenance support. In addition, the controller 10 updates the skill information of the service person dispatched and the held component information of the service person dispatched in the service person DB 20b based on the result of the maintenance support. Since the skill information and the held component information are updated based on the result of the maintenance support, a service person can be selected based on the updated skill information and the updated held component information in the next and later service person selection.

The controller 10 updates a task state of the service person dispatched from “performing” to a next state in the service person DB 20b. In addition, the controller 10 causes data in which the service person selection information when the service person is selected is associated with the service person actually dispatched to be stored as teaching data in the storage unit 20.

When an error occurs in the printing device, the machine-learned model and the service person selection information acquired when the error occurs are used to easily select a service person to be dispatched from among the multiple service persons.

### (5) Other Embodiment

The embodiment described above is an example of the disclosure. The disclosure may include other various embodiments as long as, upon the occurrence of an error in a printing device, the service person selection information is acquired and the acquired service person selection information and the machine-learned model are used to select a service person to be dispatched to maintain the printing device in which the error has occurred. For example, a device to be maintained may be a multi-functional device having a printing function, an image reading function, a facsimile communication function, and the like.

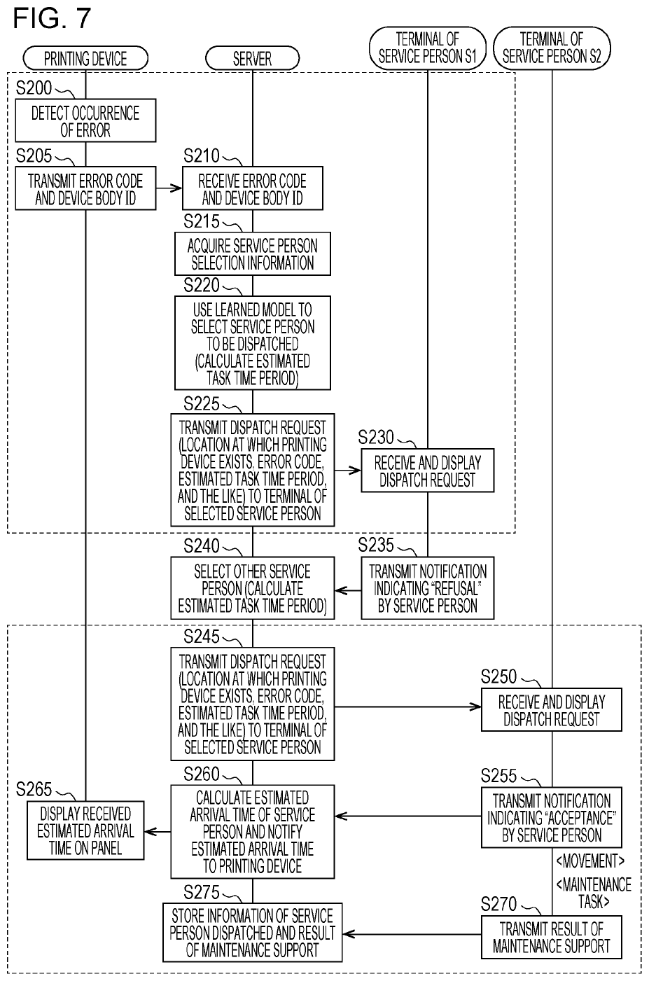

The embodiment describes the sequence in which the service person associated with the node that is included in the machine-learned model and from which the largest value is output is requested to be dispatched and the service person accepts the dispatch request. FIG. 7 is a sequence diagram depicting an example of a sequence in which the service person requested to be dispatched does not accept the dispatch request. Since steps S200 to S230 are common to steps S100 to S130 depicted in FIG. 6 in the sequence diagram of FIG. 7, a detailed description of steps S200 to S230 is omitted. In step S230, the mobile terminal of the service person S1 displays information attached to the dispatch request on the display. When the service person S1 enters information indicating “refusal” in the mobile terminal, the controller 210 of the mobile terminal of the service person S1 transmits a notification indicating “refusal” by the service person to the server 1 (in step S235).

Upon receiving the notification indicating “refusal”, the controller 10 of the server 1 selects a service person again (in step S240). Specifically, the controller 10 newly selects the service person associated with a node from which the second largest value, which is smaller than the output value of the node associated with a service person selected in step S220, is output. This example describes that the service person S2 is selected. Subsequent steps S245 to S275 are a sequence in the case where the newly selected service person S2 accepts the dispatch request. Thus, the flow of steps S245 to S275 is the same as or similar to that of steps S125 to S155 depicted in FIG. 6, except that a mobile terminal that communicates with the server 1 in steps S245 to S275 is different from the mobile terminal that communicates with the server 1 in steps S125 to S155.

In step S275, an association between the service person (S2 instead of S1 in this case) actually dispatched and the service person selection information acquired in step S215 is stored as new teaching data in the storage unit 20. Relearning may be executed using this teaching data. Specifically, the machine-learned model is subjected to the machine learning again based on a result indicating whether the selected service person has accepted the dispatch request. More specifically, when the service person selection information acquired in step S215 is input to the machine-learned model, the machine-learned model may be relearned so that a value output from the node associated with the service person (service person (S1 in this example) associated with the node that is included in the machine-learned model and from which the largest value is output) selected first is 0, a value output from the node associated with the service person (service person (S2 in this example) associated with the node that is included in the machine-learned model and from which the second largest value is output) selected second is 1, and values output from the nodes associated with the other service persons are 0.

When the machine-learned model is relearned in the foregoing manner and the service person selection information has a certain characteristic, it is possible to learn that a certain service person does not accept a dispatch request but another service person accepts the dispatch request. For example, it is learned that a certain service person tends to refuse a dispatch request to perform a maintenance task for a certain specific error code. As a result, when the service person selection information has the certain characteristic, it is possible to reduce the probability that a service person who may not accept a dispatch request is selected, and it is possible to shorten a time period up to the time when a service person to be actually dispatched is determined.

The machine-learned model may be subjected to the machine learning again based on a result of maintenance support by a service person dispatched. For example, when an error is not resolved on a current visit, an actual task time period is significantly longer than an estimated task time period, or the like, the machine-learned model may be learned again. Specifically, when the service person selection information acquired in step S215 is input to the machine-learned model, the machine-learned model may be learned again so that an output value of a node associated with a service person selected by the machine-learned model immediately after a service person actually dispatched is 1, an output value of a node associated with the service person actually dispatched is 0, and output values of nodes associated with the other service persons are 0. By learning the machine-learned model in the foregoing manner, it is possible to reduce the probability that a service person who is unlikely to be able to resolve an error within an estimated task time period on a single visit is selected.

The input and output of the machine learning model depicted in FIG. 4 are an example. The machine learning model may have an arbitrary configuration as long as a service person to be dispatched is selected based on the service person selection information when an error occurs. The example depicted in FIG. 4 assumes the case where the number of service persons holding a qualification for printing devices of this model type is 5, and the model receives the information on the 5 persons and outputs information of any of the 5 persons. However, while it is expected that the number of service persons who hold the qualification for printing devices of this model type increases, the model may be configured so that information on, for example, 100 service persons is input to the input layer of the model (0, NULL, or the like is input to nodes associated with 95 service persons who are not present in the foregoing example) and 100 nodes of the output layer of the model are associated with the 100 service persons.

For example, a model may be built for each of combinations of the model types of printing devices and the error codes. In addition, for example, a model may be built for each of combinations of the model types of printing devices and fields to which the error codes belong. In both cases, the error codes may not be included in data to be input to the models.

For example, the model may be configured so that a dispatch request is provided to only a service person associated with a node that is among the nodes of the output layer and of which an output value is equal to or larger than a threshold (of, for example, 0.9). When a node of which an output value is equal to or larger than the threshold does not exist, the model may stand by for a certain time period (or a dispatch request is not provided to any person). Then, the service person selection information reacquired after the model stands by for the certain time period is input to the model. When output values, equal to or larger than the threshold, of nodes of the model are obtained as a result of the inputting, a dispatch request is provided to a service person associated with a node from which the largest value is output among the output values equal to or larger than the threshold.

For example, the model may be configured so that an estimated required time period, skill information, and held component information of an arbitrary single service person are input to the input layer of the model. In this case, the model may include a single output node for outputting a value (1 indicating that the service person is to be dispatched or 0 indicating that the service person is not to be dispatched) indicating whether the service person is to be dispatched or not.

In the case where the model has the foregoing configuration, when an error occurs in a printing device, the controller 10 of the server 1 selects service persons holding a qualification for the printing device and selects service persons being dispatched from among the selected service persons. Then, the controller 10 acquires, for each of the selected service persons, an estimated required time period, the number of tasks performed for each of the fields, a resolution rate for each of the fields, and the number of held components for each of the component codes. The controller 10 inputs the acquired information to the foregoing model for each of the service persons and acquires output values of the model. Then, the controller 10 may select, as a service person to be dispatched, a service person corresponding to information input to the input layer and causing the largest value to be output from the output node.

For example, the model may be configured so that an estimated required time period, skill information, and held component information of an arbitrary single service person are input to the input layer of the model. In this case, the output layer may be composed of nodes associated with service persons (holding a qualification for a model type of a printing device in which an error has occurred).

Estimated required time period information may be information on estimated required time periods up to times when the service persons perform a task of maintaining a printing device in which an error has occurred. The estimated required time period information may have any of various configurations. For example, the estimated required time period information may be information of the estimated required time periods, as depicted in FIG. 4, or may be information indirectly indicating the estimated required time periods. For example, data to be input to the model may include information indicating a location at which the printing device exists and an area (region) including the location. The data to be input to the model may include current positions of the service persons and information that indicates transportation and is to be used to calculate movement time periods included in the estimated required time periods. The data to be input to the model may include estimated remaining time periods. The estimated required time periods may include time periods other than the movement time periods and the estimated remaining time periods for maintenance tasks being performed. For example, the data to be input to the model may include a remaining time period of a rest period of a service person who is on a break.

Error information that includes the error codes may include information indicating a state (for example, the latest user operation history, an operation history of a printing device, the frequency with which the printing device is used, a temperature, a humidity, the time when an error has occurred) when an error has occurred, for example. The information indicating the state when the error has occurred may be included in the data to be input to the model.

In the disclosure, the technique for acquiring the service person selection information and using the acquired service person selection information and the machine-learned model to select a service person to be dispatched to maintain a printing device in which an error has occurred upon the occurrence of the error in the printing device is applicable as a program and a method. The foregoing system, the programs, the method of selecting a service person, and the machine learning method may be implemented as a single device or may be enabled by using components included in multiple devices. The foregoing system, the programs, the method of selecting a service person, and the machine learning method may be enabled in various aspects. The system, the programs, the method of selecting a service person, and the machine learning method may be enabled by software and hardware or may be changed when necessary. The disclosure includes a recording medium storing a program that controls the system. The recording medium storing the program may be a magnetic recording medium, a semiconductor memory, or any recording medium that will be developed in the future.

In the foregoing embodiment, the printing device is treated as a device to be maintained. However, the disclosure may be applied to an error that occurs in another electronic device, for example such as a projector or a robot, and a service person may be dispatched to maintain the electronic device.

What is claimed is:

1. A service person selecting device comprising:
a storage that stores a machine-learned model subjected to machine learning using teaching data in which service person selection information, which is at least one of error information of a printing device, estimated required time period information of service persons that is related to estimated required time periods up to times when the service persons perform a task of maintaining the printing device in which an error has occurred, skill information of the service persons, and held component information of the service persons, is associated with a service person dispatched to maintain the printing device in which the error has occurred; and
a controller that acquires the service person selection information and uses the acquired service person selection information and the machine-learned model to select a service person to be dispatched to maintain the printing device in which the error has occurred upon the occurrence of the error in the printing device.

2. The service person selecting device according to claim 1, wherein
the estimated required time period information includes information of transportation available to the service persons and transportation information on the transportation from current positions of the service persons to a location at which the printing device exists.

3. The service person selecting device according to claim 1, wherein
when the service persons perform maintenance tasks, the estimated required time period information includes estimated remaining time periods up to the completion of the maintenance tasks by the service persons.

4. The service person selecting device according to claim 1, wherein
the machine-learned model is subjected to the machine learning again based on a result indicating whether the selected service person has accepted a dispatch request provided to the selected service person.

5. The service person selecting device according to claim 1, wherein
the skill information of the service person dispatched is updated based on a result of maintenance support by the service person dispatched.

6. A machine learning method comprising:
acquiring teaching data in which service person selection information, which is at least one of error information of a printing device, estimated required time period information of service persons that is related to estimated required time periods up to times when the service persons perform a task of maintaining the printing device in which an error has occurred, skill information of the service persons, and held component information of the service persons, is associated with a service person dispatched to maintain the printing device in which the error has occurred; and
executing, based on the teaching data, machine learning on a model for receiving the service person selection information and outputting information of a service person to be dispatched to maintain the printing device in which the error has occurred.

7. A service person selecting device comprising:
a storage that stores a machine-learned model subjected to machine learning using teaching data in which service person selection information, which is at least one of error information of an electronic device, estimated required time period information of service persons that is related to estimated required time periods up to times when the service persons perform a task of maintaining the electronic device in which an error has occurred, skill information of the service persons, and held component information of the service persons, is associated with a service person dispatched to maintain the electronic device in which the error has occurred; and
a controller that acquires the service person selection information and uses the acquired service person selection information and the machine-learned model to select a service person to be dispatched to maintain the electronic device in which the error has occurred upon the occurrence of the error in the electronic device.
